(19) United States
(12) Patent Application Publication
(10) Pub. No.: US 2022/0161803 A1
(43) Pub. Date: May 26, 2022

(54) Vehicle and Control Method Thereof

(71) Applicants: Hyundai Motor Company, Seoul (KR); Kia Corporation, Seoul (KR)

(72) Inventor: Yoan Oh, Ansan-si (KR)

(21) Appl. No.: 17/451,401

(22) Filed: Oct. 19, 2021

(30) Foreign Application Priority Data
Nov. 24, 2020 (KR) 10-2020-0159379

(51) Int. Cl. B60W 40/08; G06F 3/0482; B60W 50/14; B60W 60/00; B60N 2/00

(52) U.S. Cl. CPC B60W 40/08; G06F 3/0482; B60W 50/14; B60W 2050/146; B60W 60/0051; B60N 2/002; B60W 2540/221; B60W 60/001

(57) ABSTRACT

An embodiment vehicle includes a detector configured to obtain information on whether a rear occupant is present in a rear seat and a state of the rear occupant, an audio, video, navigation, telematics terminal (AVNT) device configured to output the information on the state of the rear occupant, and a controller configured to, in response to detecting that the rear occupant is present in the rear seat, control the detector to obtain the information on the state of the rear occupant in real time and control the AVNT device to allow a user interface to be output, wherein the user interface is based on a position of the rear occupant and the information on the state of the rear occupant.

### CROSS-REFERENCE TO RELATED APPLICATIONS

This application claims the benefit of Korean Patent Application No. 10-2020-0159379, filed on Nov. 24, 2020, which application is hereby incorporated herein by reference.

### TECHNICAL FIELD

The disclosure relates to a vehicle and a control method thereof.

### BACKGROUND

In order to prevent a driver from getting out of a vehicle while leaving a child in a rear seat, a vehicle equipped with a rear occupant alert (ROA) has been available.

The ROA is a technology that detects whether a child is still in the vehicle when the driver gets out, and sends an alarm or message to prevent a safety accident in advance.

The ROA that is recently provided may make a warning sound only when a driver gets out of a vehicle, but may not provide any information about a rear occupant while driving.

### SUMMARY

The disclosure relates to a vehicle and a control method thereof. Particular embodiments relate to a rear occupant alert (ROA).

Therefore, an embodiment of the disclosure provides a vehicle and a control method thereof capable of implementing an ROA on an audio, video, navigation, telematics terminal (AVNT) device while driving.

Additional embodiments of the disclosure will be set forth in part in the description which follows and, in part, will be obvious from the description, or may be learned by practice of the disclosure.

In accordance with an embodiment of the disclosure, a vehicle includes a detector configured to obtain information on whether an occupant is present in a rear seat and a state of the rear occupant, an AVNT device configured to output the state information about the rear occupant, and a controller configured to, when detecting the presence of the rear occupant, control the detector to obtain the state information about the rear occupant in real time, and configured to control the AVNT device to allow a user interface, which is based on a position of the rear occupant and the state information about the rear occupant, to be output.

The controller may be configured to, when detecting an abnormality of the rear occupant, control the AVNT device to notify the abnormality.

The controller may be configured to identify a level for the abnormality and configured to control the AVNT device to allow one of a corresponding menu or an automatic control to be executed based on the level.

The controller may be configured to change the user interface to allow a user to select the corresponding menu when the level is a first level.

The controller may be configured to execute the automatic control of the vehicle when the level is a second level.

The vehicle may further include communication circuitry configured to communicate with a server, and the controller may be configured to control the communication circuitry to transmit the state information about the rear occupant to the server.

The detector may include a pressure sensor embedded in the rear seat, and the detector may be configured to provide the controller with whether the occupant is present in the rear seat, and a seating position of the rear occupant based on a pressure detected by the pressure sensor.

The detector may include a heart rate sensor configured to measure a heart rate of the rear occupant, and the detector may be configured to provide the controller with the heart rate to determine the abnormality of the rear occupant based on the heart rate of the rear occupant.

The detector may include an infrared sensor configured to measure a temperature of the rear occupant, and the detector may be configured to provide the controller with the temperature to determine the abnormality of the rear occupant based on the temperature of the rear occupant.

The detector may include an illuminance sensor configured to measure an illuminance of the rear seat, and the controller may be configured to, when the rear occupant is in a drowsy state or a sleep state, allow a user to adjust an electric curtain in the rear seat or allow the electric curtain to be automatically closed based on the measured illuminance.

The controller may control the AVNT device to allow the user interface including a menu corresponding to the abnormality to be output.

In accordance with another embodiment of the disclosure, a control method of a vehicle includes obtaining information on whether an occupant is present in a rear seat and a state of the rear occupant, outputting the state information about the rear occupant, and when detecting the presence of the rear occupant, controlling the detector to obtain the state information about the rear occupant in real time, and controlling an AVNT device to allow a user interface, which is based on a position of the rear occupant and the state information about the rear occupant, to be output.

The controlling of the AVNT device may, when detecting an abnormality of the rear occupant, control the AVNT device to notify the abnormality.

The controlling of the AVNT device may identify a level for the abnormality and control the AVNT device to allow one of a corresponding menu or an automatic control to be executed based on the level.

The controlling of the AVNT device may change the user interface to allow a user to select the corresponding menu when the level is a first level.

The controlling of the AVNT device may execute the automatic control of the vehicle, when the level is a second level.

The obtaining of the state information of the rear occupant may include a pressure sensor embedded in a rear seat, and providing the controller with whether the occupant is present in the rear seat, and a seating position of the rear occupant based on a pressure detected by the pressure sensor.

The obtaining of the state information of the rear occupant may include a heart rate sensor configured to measure a heart rate of the rear occupant, and providing the controller with the heart rate to determine the abnormality of the rear occupant based on the heart rate of the rear occupant.

The obtaining of the state information of the rear occupant may include an infrared sensor configured to measure a temperature of the rear occupant, and providing the controller with the temperature to determine the abnormality of the rear occupant based on the temperature of the rear occupant.

The controlling of the AVNT device may control the AVNT device to allow the user interface including a menu corresponding to the abnormality to be output.

In accordance with another embodiment of the disclosure, a computer program stored on a recording medium to execute steps by coupling to a computing device is provided, and the steps include the steps of obtaining information on whether an occupant is present in a rear seat and a state of the rear occupant, outputting the state information about the rear occupant, and when detecting the presence of the rear occupant, controlling the detector to obtain the state information about the rear occupant in real time, and controlling an AVNT device to allow a user interface, which is based on a position of the real occupant and the state information about the rear occupant, to be output.

### BRIEF DESCRIPTION OF THE DRAWINGS

These and/or other embodiments of the disclosure will become apparent and more readily appreciated from the following description of embodiments, taken in conjunction with the accompanying drawings, in which:

FIG. 1 is a view illustrating an internal structure of a vehicle according to an embodiment of the disclosure;

FIG. 2 is a block diagram illustrating the vehicle according to an embodiment of the disclosure;

FIGS. 3 to 5 are flow charts of a control method of the vehicle according to an embodiment of the disclosure;

FIG. 6 is a view illustrating an embodiment of a screen of an AVNT device;

FIG. 7 is a view illustrating an embodiment of the screen of the AVNT device; and

FIGS. 8 to 11 are views illustrating embodiments related to a state of a rear occupant.

### DETAILED DESCRIPTION OF ILLUSTRATIVE EMBODIMENTS

In the following description, like reference numerals refer to like elements throughout the specification. Well-known functions or constructions are not described in detail since they would obscure one or more exemplar embodiments with unnecessary detail. Terms such as “unit”, “module”, “member”, and “block” may be embodied as hardware or software. According to embodiments, a plurality of “units”, “modules”, “members”, and “blocks” may be implemented as a single component or a single “unit”, “module”, “member”, and “block” may include a plurality of components.

It will be understood that when an element is referred to as being “connected” to another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

It will be understood that, although the terms first, second, third, etc., may be used herein to describe various elements, they should not be limited by these terms. These terms are only used to distinguish one element from another element.

As used herein, the singular forms “a,” “an” and “the” are intended to include the plural forms as well, unless the context clearly indicates otherwise.

An identification code is used for the convenience of the description but is not intended to illustrate the order of each step. Each step may be implemented in an order different from the illustrated order unless the context clearly indicates otherwise.

Reference will now be made in detail to embodiments of the disclosure, examples of which are illustrated in the accompanying drawings.

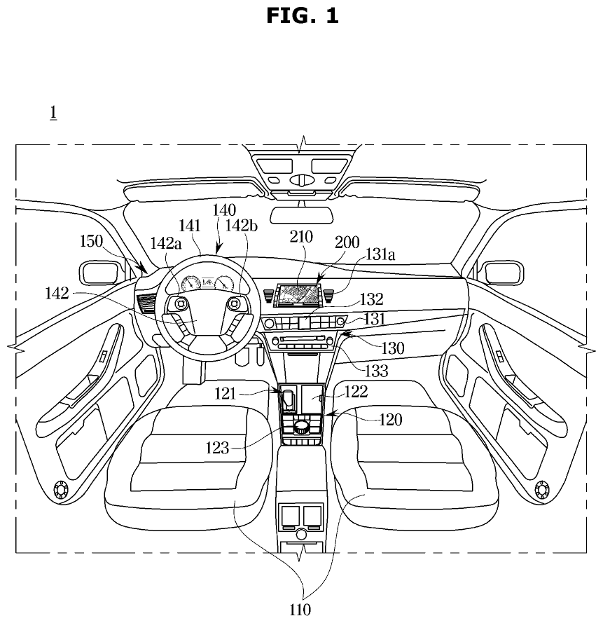

FIG. 1 is a view illustrating an internal structure of a vehicle according to an embodiment of the disclosure.

Referring to FIG. 1, a vehicle 1 may include a seat no on which a driver or the like rides, and a dashboard 150 in which a gear box 120, a center fascia 130, and a steering wheel 140 are provided.

A gear lever 121 configured to change a speed of the vehicle 1 and a touch pad 122 configured to control an operation of the vehicle 1 may be installed in the gear box 120. Further, a dial operator 123 may be selectively installed as needed.

An air conditioner 131, a clock 132, an audio device 133, and an AVNT device 200 may be installed in the center fascia 130.

The air conditioner 131 may keep air inside the vehicle 1 fresh by controlling the temperature, humidity, air cleanliness, and airflow of the air inside of the vehicle 1. The air conditioner 131 may include at least one outlet installed in the center fascia 130 so as to discharge air. A button or a dial may be installed in the center fascia 130 to control the air conditioner 131. A user, such as a driver, may control the air conditioner 131 by using the button or the dial disposed on the center fascia 130.

The clock 132 may be provided around the button or the dial for controlling the air conditioner 131.

The audio device 133 includes an operation panel provided with a plurality of buttons for performing functions of the audio device 133. The audio device 133 may provide a radio mode for providing a radio function and a media mode for playing audio files of various storage media including audio files.

The AVNT device 200 is a device configured to integrally perform audio, video, and navigation functions in the vehicle. The AVNT device 200 may provide a radio service that plays a radio based on a terrestrial radio signal, an audio service that plays a compact disk (CD), a video service that plays a digital versatile disk (DVD), a navigation service that performs destination guidance, and a telephone service that controls whether to receive an incoming call of a mobile terminal connected to the vehicle.

The AVNT device 200 may further include telematics that is a communication service, and thus a user can use various services in the vehicle. In comparison with an existing audio, video, navigation (AVN) device, the AVNT device 200 may communicate with an external server to allow a user to use various contents, such as navigation updates, weather, music, and news, without a separate communication device.

The AVNT device 200 may selectively display at least one of an audio screen, a video screen, and a navigation screen on the display 230. According to an embodiment, the AVNT device 200 may display an application screen downloaded through the AVNT device 200 on the display 230, which will be described later in a related section.

The AVNT device 200 may be provided to be embedded around the center fascia 130 in the vehicle as shown in FIG. 1, and may be mounted in a movable manner or a detachable manner.

The steering wheel 140 may be a device configured to steer the vehicle 1, and may include a rim 141 held by the driver and a spoke 142 connected to a steering system of the vehicle 1 and configured to connect the rim 141 to a hub of a rotation shaft for the steering. According to embodiments, manipulation devices 142a and 142b may be formed in the spoke 142 to control various devices inside the vehicle 1, such as an audio device.

In addition, according to embodiments, the dashboard 150 may further include various instrument panels configured to indicate a driving speed of the vehicle and revolutions per minute (RPM) or fuel residual quantity, and a glove box in which various things are stored.

The vehicle 1 may provide a navigation map screen, on which a driving route of the vehicle 1 is displayed, on the display 230 of the AVNT device 200 by executing an application stored in the AVNT device 200.

According to embodiments of the disclosure, the AVNT device 200 may be controlled based on data of various sensors mounted on the vehicle 1, and rear occupant alert (ROA) may be implemented by the AVNT device 200 while driving. A detailed description thereof will be described below.

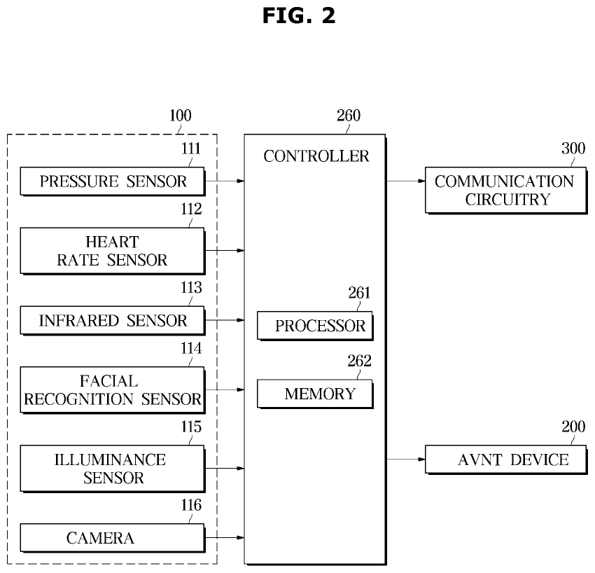

FIG. 2 is a block diagram illustrating the vehicle according to an embodiment of the disclosure.

A controller 260 is configured to control the AVNT device 200 and communication circuitry 300 based on sensor data obtained by a detector 100.

In this case, the detector 100 is a sensor data acquisition device configured to detect a state of a rear occupant seated in a second-row seat or a third-row seat, and the detector 100 includes a pressure sensor 111, a heart rate sensor 112, an infrared sensor 113, a facial recognition sensor 114, an illuminance sensor 115 and a camera 116. As described above, a position, in which the detector 100 is implemented, is not limited to the second-row or third-row seats, and thus the position may be implemented at all places other than a driver's seat when the vehicle is a high-occupancy vehicle such as a van.

The pressure sensor 111 may be embedded in the rear seat and configured to detect a change in pressure caused by an occupant seating in the rear seat so as to provide information about whether an occupant is present in the rear seat. Further, a plurality of pressure sensors 111 may be provided for each seat, and may provide information on a position in which a rear occupant is seated.

The heart rate sensor 112 may be provided in the rear seat so as to measure a heart rate of the rear occupant. The heart rate sensor 112 may be provided on a body of the vehicle 1. Alternatively, the heart rate sensor 112 may be provided in a watch that is worn by the rear occupant and configured to perform a short-distance communication (e.g., Bluetooth) and thus the heart rate sensor 112 may provide information about the heart rate of the rear occupant through the short-distance communication to the vehicle 1.

The infrared sensor 113 may be provided on the rear seat, so as to measure a body temperature of the rear occupant. The infrared sensor 113 may be provided on the body of the vehicle 1. Alternatively, the infrared sensor 113 may be provided in a watch that is worn by the rear occupant and configured to perform a short-distance communication and thus the infrared sensor 113 may provide information about the body temperature of the rear occupant through the short-distance communication to the vehicle 1. In addition, the infrared sensor 113 may be configured to measure the temperature of the rear seat as well as the body temperature of the rear occupant.

The facial recognition sensor 114 may be provided at a position capable of recognizing the rear occupant's face, so as to detect various facial states, such as the rear occupant's eyes, nose and mouth.

The illuminance sensor 115 may be provided on the rear seat, so as to measure an illuminance. For example, the illuminance sensor 115 may detect the illuminance caused by sunlight coming from the outside.

The camera 116 may be provided at a position capable of recognizing the entire rear occupant so as to image the entire body of the rear occupant. The controller 260 may output a screen of a posture of the rear occupant on the AVNT device 200 in real time based on the image data obtained from the camera 116.

The controller 260 may control at least one of the AVNT device 200 and the communication circuitry 300 based on the sensor data obtained by the above-described detector 100.

In response to a user input, the controller 260 may control the AVNT device 200 to execute a program according to embodiments of the disclosure.

The controller 260 may determine whether or not an occupant is present in the rear seat, through the pressure sensor 111, and when the presence of the rear occupant is identified, the controller 260 may identify a seating position of the rear occupant and a position of the rear occupant. In this case, the controller 260 may output a 2D or 3D image, to which the seating position of the rear occupant is applied, on a region of a screen that is output on the AVNT device 200. Further, according to an embodiment, the controller 260 may obtain weight information of the rear occupant through the pressure sensor 111, and when the information indicates that the weight is equal to or less than a predetermined weight, the controller 260 may determine that the rear occupant is an infant. In this case, when the rear occupant is an infant, the controller 260 may allow a program, which is according to an embodiment, to be automatically executed or may automatically output a menu icon so as to allow a user to selectively execute the program.

The controller 260 may determine an abnormality of the rear occupant based on sensor data obtained by the detector 100, and inform the user of the abnormality of the rear occupant through the AVNT device 200.

For example, when the heart rate of the rear occupant obtained through the heart rate sensor 112 is outside of a predetermined range, the controller 260 may determine that the rear occupant has the abnormality, and the controller 260 may inform the user of the occurrence of the abnormality by controlling an image or a sound of the AVNT device 200.

Further, when the temperature of the rear occupant obtained through the infrared sensor 113 exceeds a predetermined temperature, the controller 260 may determine that the rear occupant has the abnormality, and the controller 260 may inform the user of the occurrence of the abnormality by controlling an image or a sound of the AVNT device 200.

Further, the controller 260 may determine a drowsy state or a sleep state of the rear occupant based on the facial state of the rear occupant obtained through the facial recognition sensor 114, and may inform the user of the state of the rear occupant by controlling an image or a sound of the AVNT device 200. In this case, the controller 260 may determine an illuminance of the rear seat through the illuminance sensor 115 and when it is determined that the rear occupant is in the drowsy state or the sleep state, the controller 260 may allow the user to control an electric curtain in the rear seat or allow the electric curtain to be automatically closed. For example, when the measured illuminance is equal to greater than a predetermined illuminance and when the rear occupant is in the drowsy state or the sleep state, the controller 260 may output an icon, which is to control the electric curtain, on an image of the AVNT device so as to allow the user to adjust the electric curtain, or the controller 260 may control the electric curtain to be automatically closed.

When the rear occupant is in the drowsy state or the sleep state, the controller 260 may control the AVNT device 200 to automatically reduce a sound of the AVNT device 200 or control the AVNT device 200 to be in a mute state.

Further, the controller 260 may control a menu icon, which is to control the air conditioner, to be output on the screen of the AVNT device 200 based on the temperature of the rear seat obtained through the infrared sensor 113 or an amount of sunlight in the rear seat obtained through the illuminance sensor 115. Alternatively, the controller 260 may control the menu icon not to be output and control the air conditioner to be automatically operated without the user input.

The controller 260 may include at least one memory 262 in which a program for performing the above-described operation and an operation to be described later is stored, and at least one processor 261 configured to execute the stored program. When the controller 260 includes a plurality of memories 262 and a plurality of processors 261, the plurality of memories 262 and the plurality of processors 261 may be directly provided on one chip or physically separated from each other.

In the above, the configuration of the vehicle 1 and the operation for each configuration according to embodiments of the disclosure have been described. Hereinafter each operation of a control method performed based on the above-described configuration will be described in detail.

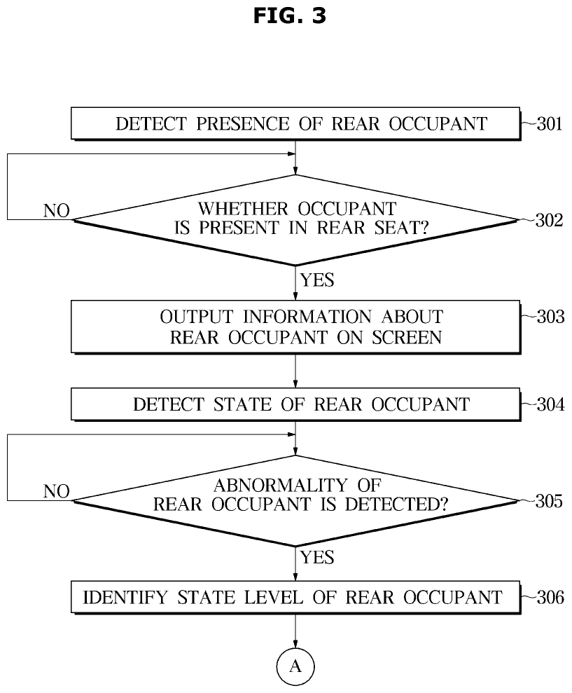

FIGS. 3 to 5 are flow charts of a control method of the vehicle according to an embodiment of the disclosure.

The controller 260 detects the presence of the rear occupant (301). As described above, the detection of the presence of the rear occupant may be performed by the pressure sensor 111. In addition, it is possible to detect the presence of the rear occupant based on a seat belt reminder (SBR) sensor (not shown) other than the pressure sensor 111.

When the controller 260 detects the presence of the rear occupant (Yes at 302), the controller 260 outputs information about the rear occupant on the screen (303). The information about the rear occupant may include information that the rear occupant is an infant and information on a position in which the rear occupant is seated.

The controller 260 continuously detects the state of the rear occupant (304). As described above, the controller 260 receives sensor data obtained by the detector 100 including various sensors in real time.

When the abnormality of the rear occupant is detected based on sensor data obtained by the detector wo (Yes at 305), the controller 260 may identify a state level of the rear occupant (306). The state level represents a criterion based on the severity of the abnormality of the rear occupant. For example, when the rear occupant has a slight fever, the controller 260 may determine the state of the rear occupant as a first level, which may be solved by performing a predetermined measure in the vehicle 1. However, when the rear occupant has a high fever or finds it difficult to breathe, the controller 260 may determine the state of the rear occupant as a second level and make a request to the outside to have rapid first aid. According to embodiments of the disclosure, the state is classified into two levels such as the first level and the second level for convenience of description, but is not limited thereto. Alternatively, the state may be classified into multiple levels according to the medical classification or user setting, and implemented to perform a control for each level.

When the vehicle 1 according to an embodiment detects the presence of the rear occupant, the vehicle 1 may control the detector 100 to obtain the state information of the rear occupant in real time, and control the AVNT device 200 to output a user interface based on the position of the rear occupant, and the state information of the rear occupant. In this case, the state information of the rear occupant is based on various sensor data obtained by the detector 100. The user interface according to embodiments of the disclosure may be output on the condition that the rear occupant is identified as an infant based on the weight value of the rear occupant.

Meanwhile, the vehicle 1 according to an embodiment may control the AVNT device 200 to execute one of a corresponding menu or automatic control based on the level of the abnormality.

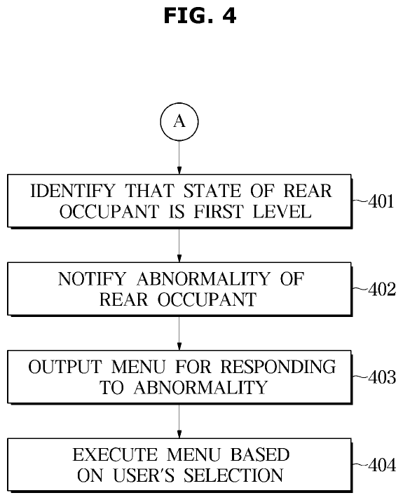

FIG. 4 is a flow chart of the control method to be performed when the abnormality of the rear occupant is relatively slight.

When it is identified that the state of the rear occupant is the first level (401), the controller 260 controls the AVNT device 200 to notify the abnormality of the rear occupant (402).

The controller 260 determines the abnormality of the rear occupant and controls a menu for responding to the abnormality to be output on the screen of the AVNT device 200 (403). For example, when the rear occupant closes his or her eyes for a predetermined period of time (facial recognition sensor-based) and when there is no movement of the body of the rear occupant (camera-based), the controller 260 determines that the rear occupant is in the sleep state, and outputs a menu for controlling a lighting device in a region of the screen of the AVNT device 200. In addition, when the body temperature of the rear occupant is higher or lower than a normal value, the controller 260 outputs a menu for controlling the air conditioner on a region of the screen of the AVNT device 200. In addition, when the illuminance of the rear seat is high (illuminance sensor-based), when the rear occupant's eye condition is different from usual, or when the rear occupant's gaze is in a direction opposite to a window side (facial recognition sensor-based), the controller 260 outputs a menu for controlling the electric curtain in a region of the screen of the AVNT device 200.

The controller 260 executes a menu based on the user's selection (404).

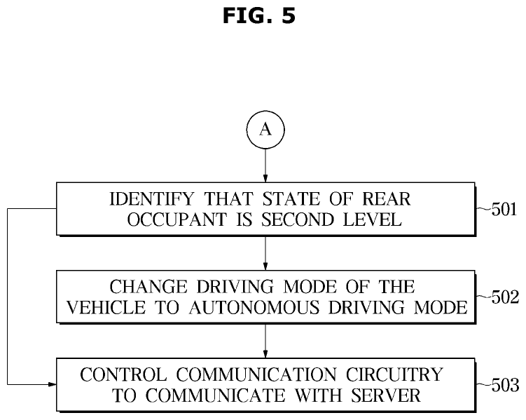

FIG. 5 is a flow chart of the control method to be performed when the abnormality of the rear occupant is the second level higher than the first level.

The first level described above is a condition in which the rear occupant's state is slight, and corresponds to a self-action condition that may be solved by simple measures that may be performed in the vehicle 1, and the second level to be described later is a condition in which the rear occupant's state is relatively severe, and corresponds to a condition that requires a request to the outside.

When it is identified that the state of the rear occupant is the second level (501), the controller 260 may change a driving mode of the vehicle 1 to an autonomous driving mode in consideration that the driver will pay more attention to the rear occupant than the driving (502). In this case, the controller 260 enters the autonomous driving mode without a user's selection input, or outputs a message asking the user whether to switch to the autonomous driving mode, and allows the user to enter the autonomous driving mode according to a user's confirmation input.

Further, the controller 260 may control the communication circuitry 300 to communicate with a server (not shown) (503). For example, when the abnormality of the rear occupant is severe, the controller 260 may transmit the vital state of the rear occupant obtained by the detector 100 to the server. In this case, the server may correspond to a communication system installed in a place that can perform the first aid for the rear occupant, such as an emergency center.

According to an embodiment, when it is identified that the state of the rear occupant is the second level, the controller 260 may change the driving mode of the vehicle 1 to the autonomous driving mode and control the vehicle 1 to drive to a destination of the vehicle 1 that is a hospital closest to a current location.

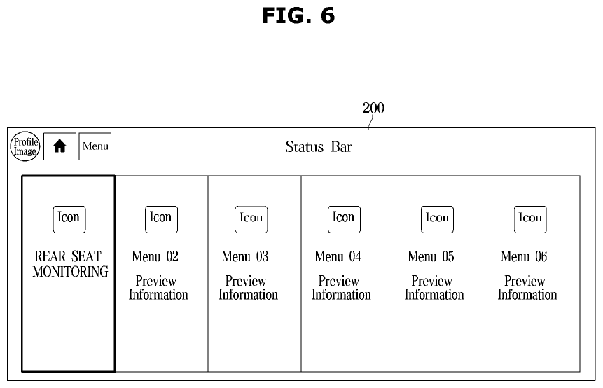

FIG. 6 illustrates an embodiment of the screen of the AVNT device 200. Particularly, FIG. 6 may be a screen output by the user selecting the entire menu, or a screen output automatically by the controller 260 detecting that the rear occupant is an infant. For example, when the controller 260 detects that the rear occupant is an infant, the controller 260 may control the AVNT device 200 to output a screen, on which an icon for executing a rear seat monitoring function, on the screen that is currently output.

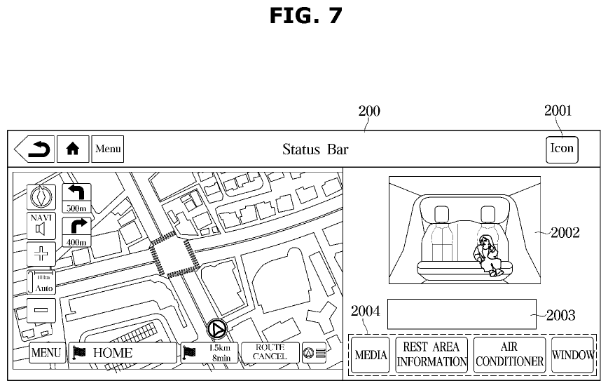

FIG. 7 illustrates an embodiment of the screen of the AVNT device 200. Particularly, FIG. 7 illustrates a screen in which the rear seat monitoring function according to embodiments of the disclosure is executed. Unlike FIG. 6, when the controller 260 detects that the rear occupant is an infant, the controller 260 may control the AVNT device 200 to allow the rear seat monitoring function to be executed immediately as illustrated in FIG. 7.

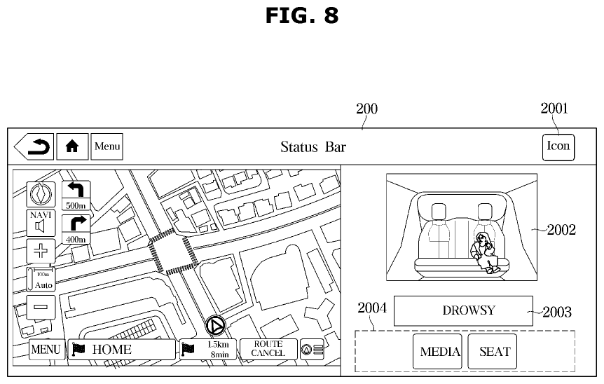

Particularly, a first region 2001 displayed on the screen of the AVNT device 200 corresponds to an indicator indicating that the rear seat monitoring function is being executed. A second region 2002 corresponds to a screen on which the rear occupant seated in the rear seat is checked in real time. The second region 2002 may be a screen on which an image obtained by the camera is output in real time, or a screen on which a 2D image or a 3D image is simply displayed and the user's state is distinguished in color. A third region 2003 corresponds to a region in which the state information of the rear occupant is displayed. For example, the AVNT device 200 may output the state of the rear occupant through text or an image on the third region. A fourth region 2004 corresponds to a region for displaying a menu for responding to the abnormality of the rear occupant. The fourth region 2004 may display a predetermined menu icon when in an initial execution stage of the rear seat monitoring function or when there is no abnormality. For example, the AVNT device 200 may output a basic menu that allows the driver to control the air conditioner, the light device or the electronic curtain of the rear seat when in the initial execution stage of the rear seat monitoring function or when there is no abnormality. When the abnormality of the rear occupant is detected, the AVNT device 200 may change the fourth region 2004 to display a menu suitable for the abnormality. A specific embodiment will be described with reference to FIGS. 8 to 11.

FIGS. 8 to 11 are views illustrating embodiments related to a state of a rear occupant.

FIG. 8 illustrates a condition in which the rear occupant is in the drowsy state. The AVNT device 200 according to the embodiment may display that the rear occupant is in the drowsy state on the third region 2003, and display a media menu icon, which is to reduce a sound volume of a media, on the fourth region 2004 so as to allow the rear occupant to sleep comfortably. Further, the AVNT device 200 may output a seat control menu icon on the fourth region 2004 to allow the driver to control the rear seat. Although not shown, when the rear occupant is in the drowsy state, the AVNT device 200 may output a lighting device control icon, which is to control a light of the rear seat, on the fourth region 2004.

Further, when the rear occupant is not in the drowsy state, the AVNT device 200 according to the embodiment may display the media menu icon, which is to increase the sound volume of the media, on the fourth region 2004. In addition, in order to provide various media services to the rear occupant who are not in the drowsy state, the AVNT device 200 may display an icon, which is to select previously preferred contents (e.g., children's song, classics, etc.), on the fourth region 2004.

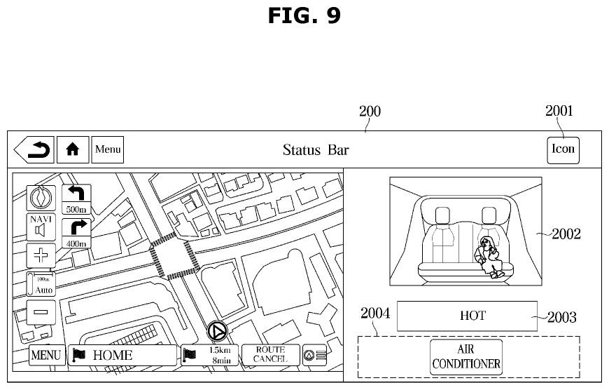

FIG. 9 illustrates a condition in which the rear occupant is in a hot state. The AVNT device 200 according to the embodiment may display that the rear occupant is in the hot state on the third region 2003, and display an air conditioner control icon to allow the driver to control the air conditioner on the fourth region 2004 so as to provide an appropriate temperature to the rear occupant.

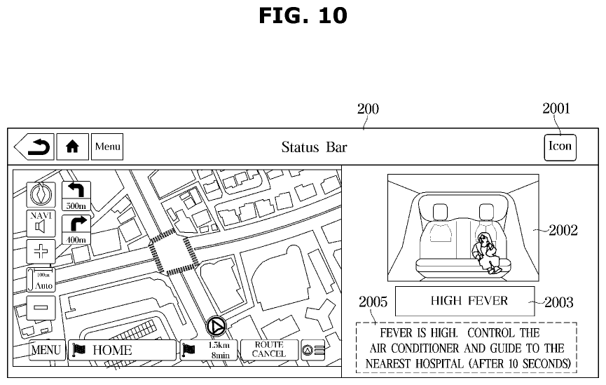

FIG. 10 illustrates a condition in which the rear occupant has a high fever. The AVNT device 200 according to the embodiment may display that the rear occupant has the high fever on the third region 2003, and display the air conditioner control icon to allow the driver to control the air conditioner on the fourth region 2004 so as to provide an appropriate temperature to the rear occupant. In addition, in order to guide the driver to a nearby hospital, the controller 260 may control the vehicle 1 to arrive at the nearby hospital by changing the destination of the navigation to the nearby hospital or changing the driving mode to the autonomous driving mode.

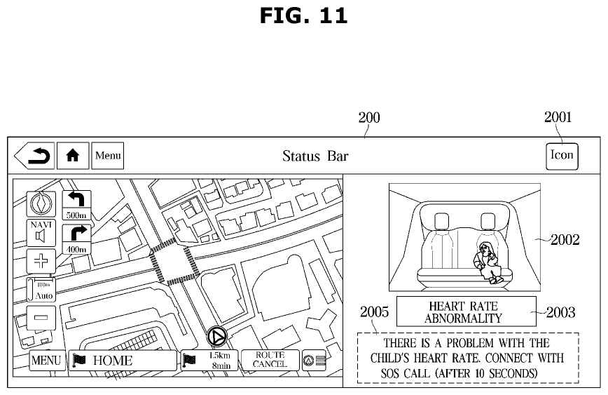

FIG. 11 illustrates a condition in which the rear occupant has an abnormal heart rate. The AVNT device 200 according to the embodiment may display that the rear occupant has the abnormal heart rate, on the third region 2003, and in order to guide the driver to a nearby hospital, the controller 260 may control the vehicle 1 to arrive at the nearby hospital by changing the destination of the navigation to the nearby hospital or changing the driving mode to the autonomous driving mode. Further, the controller 260 may control the communication circuitry 300 to transmit the rear occupant's current state to the server, thereby contributing to expediting first aid for the rear occupant at the nearby hospital in the future.

As is apparent from the above description, it is possible to prevent the driver from being distracted and to quickly respond to an emergency situation of a rear occupant.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored. For example, there may be a read only memory (ROM), a random access memory (RAM), a magnetic tape, a magnetic disk, a flash memory, and an optical data storage device.

Although a few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A vehicle comprising:
a detector configured to obtain information on whether a rear occupant is present in a rear seat and a state of the rear occupant;
an audio, video, navigation, telematics terminal (AVNT) device configured to output the information on the state of the rear occupant; and
a controller configured to, in response to detecting that the rear occupant is present in the rear seat:
control the detector to obtain the information on the state of the rear occupant in real time; and
control the AVNT device to allow a user interface to be output, wherein the user interface is based on a position of the rear occupant and the information on the state of the rear occupant.

2. The vehicle of claim 1, wherein the controller is configured to:
detect whether there is an abnormality of the rear occupant; and
in response to detecting the abnormality of the rear occupant, control the AVNT device to provide notification of the abnormality.

3. The vehicle of claim 2, wherein the controller is configured to:
identify a level for the abnormality; and
control the AVNT device to allow a corresponding menu or an automatic control of the vehicle to be executed based on the level.

4. The vehicle of claim 3, wherein the controller is configured to change the user interface to allow a user to select the corresponding menu in response to the level being a first level.

5. The vehicle of claim 3, wherein the controller is configured to execute the automatic control of the vehicle in response to the level being a second level.

6. The vehicle of claim 5, further comprising communication circuitry configured to communicate with a server, wherein the controller is configured to control the communication circuitry to transmit the information on the state of the rear occupant to the server.

7. The vehicle of claim 1, wherein:
the detector comprises a pressure sensor embedded in the rear seat; and
the detector is configured to provide the controller with information on whether the rear occupant is present in the rear seat and a seating position of the rear occupant based on a pressure detected by the pressure sensor.

8. The vehicle of claim 1, wherein:
the detector comprises a heart rate sensor configured to measure a heart rate of the rear occupant; and
the detector is configured to provide the controller with the heart rate to determine an abnormality of the rear occupant based on the heart rate of the rear occupant.

9. The vehicle of claim 1, wherein:
the detector comprises an infrared sensor configured to measure a temperature of the rear occupant; and
the detector is configured to provide the controller with the temperature to determine an abnormality of the rear occupant based on the temperature of the rear occupant.

10. The vehicle of claim 1, wherein:
the detector comprises an illuminance sensor configured to measure an illuminance of the rear seat; and
the controller is configured to allow a user to adjust an electric curtain in the rear seat or allow the electric curtain to be automatically closed based on the measured illuminance in response to the rear occupant being in a drowsy state or a sleep state.

11. A control method of a vehicle, the control method comprising:
obtaining information on whether a rear occupant is present in a rear seat and a state of the rear occupant;
outputting the information on the state of the rear occupant; and
in response to detection of the rear occupant, controlling a detector to obtain the information on the state of the rear occupant in real time, and controlling an audio, video, navigation, telematics terminal (AVNT) device to allow a user interface to be output, wherein the user interface is based on a position of the rear occupant and the information on the state of the rear occupant.

12. The control method of claim 11, further comprising:
detecting an abnormality of the rear occupant; and
controlling the AVNT device to provide notification of the abnormality.

13. The control method of claim 12, further comprising:
identifying a level for the abnormality; and
controlling the AVNT device to allow a corresponding menu or an automatic control of the vehicle to be executed based on the level.

14. The control method of claim 13, further comprising changing the user interface to allow a user to select the corresponding menu in response to the level being a first level.

15. The control method of claim 13, further comprising executing the automatic control of the vehicle in response to the level being a second level.

16. The control method of claim 12, wherein controlling the AVNT device comprises controlling the AVNT device to allow the user interface comprising a menu corresponding to the abnormality to be output.

17. The control method of claim 11, wherein obtaining the information on whether the rear occupant is present in the rear seat comprises receiving the information from a pressure sensor embedded in the rear seat, and the information on the state of the rear occupant comprises a seating position of the rear occupant based on a pressure detected by the pressure sensor.

18. The control method of claim 11, wherein obtaining the information on the state of the rear occupant comprises measuring a heart rate of the rear occupant using a heart rate sensor, the control method further comprising determining an abnormality of the rear occupant based on the heart rate of the rear occupant.

19. The control method of claim 11, wherein obtaining the information on the state of the rear occupant comprises measuring a temperature of the rear occupant using an infrared sensor, the control method further comprising determining an abnormality of the rear occupant based on the temperature of the rear occupant.

20. A non-transitory computer readable medium comprising instructions stored therein that, when executed by a computing device, performs the steps of:
obtaining information on whether a rear occupant is present in a rear seat and a state of the rear occupant;
outputting the information on the state of the rear occupant; and
in response to detecting the rear occupant is present in the rear seat, controlling a detector to obtain the information on the state of the rear occupant in real time, and controlling an audio, video, navigation, telematics terminal (AVNT) device to allow a user interface to be output, wherein the user interface is based on a position of the rear occupant and the information on the state of the rear occupant.
